(19) United States
(12) Patent Application Publication
(10) Pub. No.: US 2005/0265269 A1
(43) Pub. Date: Dec. 1, 2005

(54) Signal transmission apparatus

(75) Inventors: Yoji Saito, Tokyo (JP); Masanori Noguchi, Tokyo (JP); Hirofumi Takahashi, Tokyo (JP); Toshiki Ogawa, Tokyo (JP); Koji Demachi, Tokyo (JP); Toshiro Tomita, Tokyo (JP); Tetsuo Hoshi, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/140,135

(22) Filed: May 27, 2005

(30) Foreign Application Priority Data
May 31, 2004 (JP) 2004-160567

(51) Int. Cl. H04B 1/38

(52) U.S. Cl. 370/310

(57) ABSTRACT

A signal transmission apparatus, to which at least one field device is connected and which transmits a signal obtained from the field device to a host computer, has at least one input terminal to which a signal transmitted from the field device is inputted, a signal processing unit which generates a communication frame in conformity with a wireless communication protocol based on a signal inputted through the input terminal, and a wireless transmission unit which transmits by wireless the communication frame to the host computer.

### CROSS-REFERENCE TO RELATED APPLICATIONS

This application is based upon and claims the benefit of priority from the prior Japanese Patent Applications No. 2004-160567, filed on May 31, 2004, the entire contents of which are incorporated herein by reference.

### BACKGROUND OF THE INVENTION

1. Field of the Invention

The present invention relates to a signal transmission apparatus that collects signals transmitted by wired sensors, for example, and various field devices provided for a variety of industrial processes, or installed on the production lines of factories or in a variety of experimental facilities, that transmits signals to a host computer installed in a remote area.

2. Description of the Related Art

The following document is related to a signal transmission apparatus that collects data transmitted by wired sensors and field devices that are provided for various industrial processes, or are installed on the production lines of factories or in various experimental facilities, and that transmits the data to a host computer installed in a remote area.

JP-T-2003-533809 is referred to as a related art.

FIG. 9 is a block diagram plainly showing the configuration of an example of a signal transmission apparatus as a related art.

In FIG. 9, the signal transmission apparatus S has input/output channels CH1 and CH2, a memory m, a controller C, a power module P and a communication device D.

Since the channels CH1 and CH2 have the same structure, only the structure of channel CH1 will be described.

For channel CH1, sensors S11, S12, S13 and S14 are devices that are installed in a local area, and that detect, for example, the temperature, the pressure and the flow rate of a processing fluid. Hereinafter, not only these sensors, but also field devices are referred to simply as sensors.

A multiplexer M11 selects one of the signals output by the sensors S11 to S14, and an A/D converter AD11 performs an analog/digital conversion of the selected output.

The signal obtained by the A/D conversion is isolated by an isolator I11, and the resultant signal is transmitted to the controller C. The controller C, which is operated by a program stored in the memory m, performs various operations for the received signal, and transmits an output signal to a communication line L via the communication device D.

The communication line L, for example, is a two-wire transmission line that is connected to a control apparatus or an adjustment apparatus (not shown) and that is a host computer installed at a remote area. It should be noted that either the control apparatus or the adjustment apparatus performs a control operation for signals received via the communication line L.

With this arrangement, the multiplexer M11 selects one of the sensor signals transmitted to the sensors S11 to S14, the A/D converter AD11 performs the analog/digital conversion of the selected signal, and the isolator I11 isolates the resultant signal and transmits the obtained signal to the controller C. The controller C converts the received signal and transmits the communication signal to the communication line L via the communication device D. In this manner, the operation of the signal transmission apparatus S is performed.

The power module P is a module for supplying power P to the channels CH1 and CH2, the memory m, the controller C and the communication device D. Specifically, power P is supplied to the channels CH1 and CH2 via isolators IP11 and IP21.

Since the same structure as that of CH1 is employed for channel CH2, the same operation as described above is performed.

In this signal transmission apparatus S, signals S21, S22, S23 and S24 are respectively transmitted by the sensors S11, S12, S13 and S14 to the channels CH1 and CH2, and one of these signals is selected and transmitted to the communication line L. There is another output channel configuration wherein one of the signals received via the communication line L is output to an actuator through one of the output terminals provided for the channels.

The two channels, CH1 and CH2, are provided for the signal transmission apparatus; however, more than two channels may be provided, or an input channel and an output channel may coexist.

However, the following problems affect the above signal transmission apparatus.

Between a control apparatus or an adjustment apparatus, which is a host computer located in a remote area, and the signal transmission apparatus S located in a local area, a troublesome wiring operation using a wire cable is required.

So long as sensor signals input to the signal transmission apparatus S are signals from sensors, such as thermocouple sensors, that do not consume power, only one communication device D is required, and the total power consumption of the signal transmission apparatus S can be reduced. However, when the sensors are pressure transmission devices that transmit communication signals of 4 mA to 20 mA, that is a problem for power consumption.

That is, when sensors that consume large amounts of power are employed, the total power consumed by the signal transmission apparatus S increases with an increase in the number of input signals. Thus, a large problem affects the achievement of essential safety and the prevention of explosions.

Further, when the transmission of sensor signals employs wireless means instead of a two-wire signal line, the costs for the wiring between the host computer and the number of sensors installed in a local area can be reduced. However, providing wireless means (wireless communication interfaces) for all the sensors is expensive.

Especially during the processing performed for the control field, in the initial introduction period during which wireless sensors are still not popular, the sensors frequently are not compatible with a wireless system for measuring temperatures, pressures, flow rates and liquid levels.

### SUMMARY OF THE INVENTION

The object of the invention is to provide a signal transmission apparatus having a wireless communication unit to minimize the cost and the power consumption.

The invention provides a signal transmission apparatus, to which at least one field device is connected and which transmits a signal obtained from the field device to a host computer, having: at least one input terminal to which a signal transmitted from the field device is inputted; a signal processing unit which generates a communication frame in conformity with a wireless communication protocol based on a signal inputted through the input terminal; and a wireless transmission unit which transmits by wireless the communication frame to the host computer.

The signal transmission apparatus further has: a selection unit which selects a signal to be inputted to the signal processing unit among signals inputted through the input terminals.

The signal transmission apparatus further has a power supply unit which supplies power to a field device transmitting a signal selected by the selection unit.

In the signal transmission apparatus according to claim 2, a signal inputted to the signal processing unit is a signal transmitted from a field device to which the power supply unit supplies power.

In the signal transmission apparatus, the power supply unit is backed up by a battery.

In the signal transmission apparatus, the battery is a solar cell.

In the signal transmission apparatus, the input terminal is a terminal which transmits and receives a signal having a current of 4 mA to 20 mA.

In the signal transmission apparatus, the input terminals include a power supply terminal and a signal input terminal to which a signal transmitted from the field device is inputted.

In the signal transmission apparatus, an isolation circuit which isolates signals is disposed between the input terminal and the signal processing unit.

In the signal transmission apparatus, an isolation circuit which isolates signals is disposed between the power supply unit and the battery.

In the signal transmission apparatus, the input terminal is connected to the signal processing unit through a bus interface for digital communication.

The invention also provides a signal transmission apparatus, to which at least one field device is connected and which transmits a signal obtained from the host computer to the field device, having: a wireless receiving unit which receives a wireless signal transmitted from the host computer; and a signal processing unit which performs a signal processing for the wireless signal and outputs an operation signal to a field device corresponding to the wireless signal.

The invention also provides a signal transmission apparatus, to which at least one field devices is connected and which is disposed between the field device and a host computer, having: a signal processing unit which generates a communication frame in conformity with a wireless communication protocol based on a signal obtained from the field device, and generates a communication frame to be transmitted to the field device based on a signal in conformity with a communication protocol obtained from the host computer.

According to the signal transmission apparatus, the following advantages are obtained.

Since a signal received from a field device that is installed in a local area and is not compatible with a wireless system can bee transmitted to the host computer by radio, it is extremely effective for the introduction of wireless instrumentation.

Since a wireless interface need not be provided for all the installed field devices, the costs required for the wireless interface and the incorporated battery can be reduced, and accordingly, the total costs for the instrumentation related to a field device in the local area can be reduced.

Since power can be supplied to the field devices with using: a time-division system, the power consumed by the wireless interface can be minimized, and when a device such as a wireless interface, an incorporated battery or a solar cell must be operated by employing limited power, the invention is effective for the operation enabled period.

### BRIEF DESCRIPTION OF THE DRAWINGS

FIG. 1 is a block diagram showing the configuration of a signal transmission apparatus according to a first embodiment of the present invention;

FIG. 2 is a diagram showing an overall system including the signal transmission apparatus of the first embodiment;

FIG. 3 is a diagram showing a signal transmission apparatus according to a second embodiment of the present invention;

FIG. 4 is a diagram showing a signal transmission apparatus according to a third embodiment of the present invention;

FIG. 5 is a diagram showing an entire system, including the signal transmission apparatus of the third embodiment;

FIG. 6 is a diagram showing a signal transmission apparatus according to a fourth embodiment of the present invention;

FIG. 7 is a diagram showing a signal transmission apparatus according to a fifth embodiment of the present invention;

FIG. 8 is a diagram showing a signal transmission apparatus according to a sixth embodiment of the present invention; and

FIG. 9 is a block diagram showing the configuration of a signal transmission apparatus as a related art.

### DETAILED DESCRIPTION OF THE PREFERRED EMBODIMENTS

The preferred embodiments of the present invention will now be described in detail while referring to the drawings.

First, shown in FIG. 2 is an example wherein a signal transmission apparatus 10 according to this invention, which includes a wireless communication unit, is connected, by wire, to common sensors 21 to 2n, which are field devices employed for a process industrial field.

These sensors 21 to 2n are intended to be, for example, a differential pressure and/or pressure transmission device, and a flow meter and a thermometer that are employed in a plant industrial field.

The signal transmission apparatus 10 of the invention selects signals from one or multiple sensors 21 to 2n, and transmits a radio signal, via an antenna A, to a host computer (not shown) that is installed in a remote area.

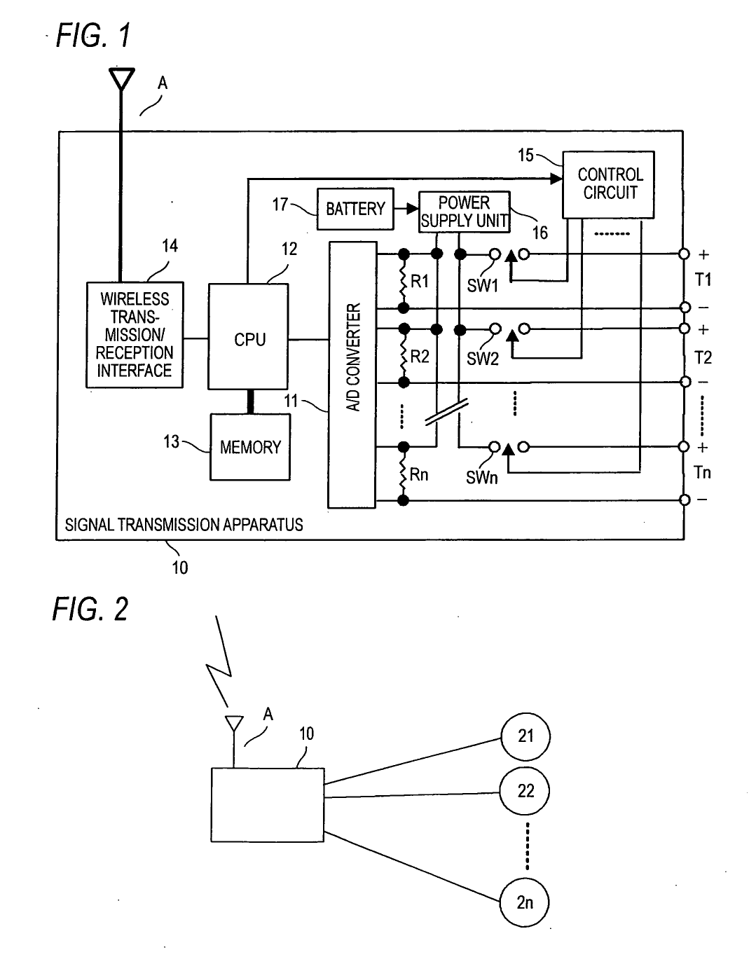

A detailed configuration block for the signal transmission apparatus 10 of the invention is shown in FIG. 1.

In FIG. 1, the sensors 21 to 2n in FIG. 2 are intended to be devices that transmit or receive signals having a current of 4 mA to 20 mA. The sensors 21 to 2n are respectively connected to input terminals T1 to Tn of the signal transmission apparatus 10.

When the signals are transmitted by the sensors 21 to 2n to the input terminals T1 to Tn, one of the signals is selected, using one of multiple switches sw1 to swn, and an A/D converter 11 performs an analog/digital conversion of the selected signal. Resistors R1 to Rn are reception resistors.

A CPU 12, which is a signal processing circuit, employs a program stored in a memory 13, for example, to perform a linearizing process or a scaling process for the digital sensor signal that is obtained by the conversion. Then, the CPU 12 generates a communication frame in conformity with a wireless communication protocol, and transmits the communication frame to a wireless transmission/reception interface 14.

In this embodiment, the wireless communication protocol is intended to be an industrial standard, such as one for a wireless LAN, for Bluetooth or for ZigBee.

The wireless transmission/reception interface 14 is used for the wireless transmission, via the antenna A, of the communication frame, which is received from the CPU 12 and which corresponds to the sensor signal, to the host computer located in a remote area.

In accordance with an instruction received from the CPU 12, a control circuit 15 changes the ON/OFF state of a switch, sw1 to swn, to select the sensor signal that is to be accepted.

The signal transmission apparatus 10 further has a power supply unit 16 for the sensors. Using the power supply unit 16, the signal transmission apparatus 10 supplies power to the sensor connected to the terminal that corresponds to the switch selected by the control circuit 15.

That is, the signal transmission apparatus 10 of this embodiment supplies power to the sensor selected using the switches sw1 to swn, and also receives a signal from the selected sensor that it transmits, by radio, to the host computer.

Furthermore, power may be supplied to the sensors in a time-division manner, the analog/digital conversion may be performed for the signal for each of the sensors to which power is supplied, and the signal obtained may be transmitted by radio. Through this process, the power consumed by the signal transmission apparatus 10 and by all the connected sensors can be minimized.

Further, a battery 17 is arranged in the signal transmission apparatus 10 in order to supply power to the signal transmission apparatus 10. However, either an external power source may be employed, or a solar cell may be employed as an internal battery or as an external power source for extending the service life of a battery.

So long as the sensors connected to the signal transmission apparatus 10 are devices that are employed in the industrial field process and that transmit or receive signals of 4 mA to 20 mA, it is generally appropriate to employ a power source, as the power supply unit 16, which can supply a direct-current voltage of at least 12 V.

Switching between sensors to supply power and the analog/digital conversion timing must be appropriately delayed until the outputs of the individual sensors are stabilized.

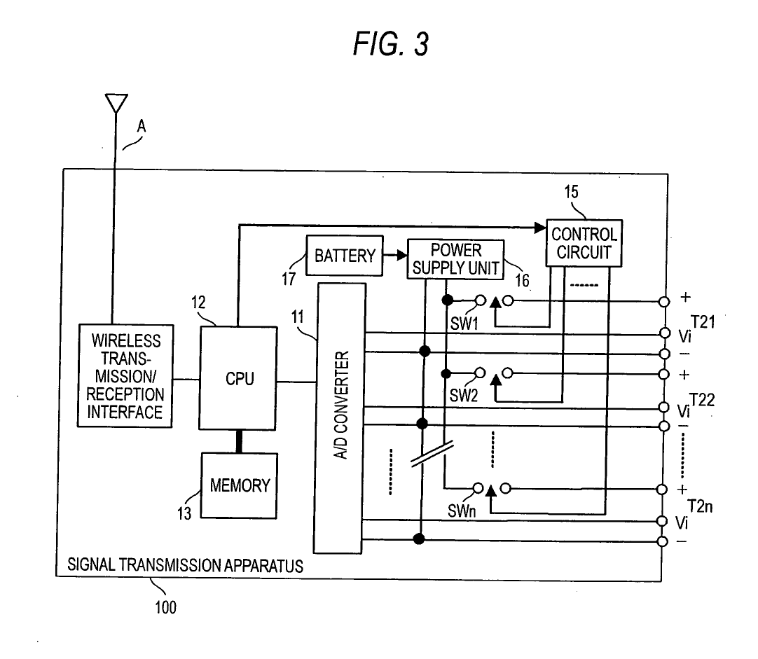

A signal transmission apparatus 100 according to a second embodiment of the present invention is shown in FIG. 3.

While in the example shown in FIG. 1 the sensors connected to the signal transmission apparatus 10 handle signals of 4 mA to 20 mA, in the example in FIG. 3, input terminals connected to sensors are changed. That is, input terminals T21 to T2n are power terminals, (+) and (−), and sensor signal input terminals, (Vi).

The configuration, except for reception resistors R1 to Rn, and the operation are the same as those in the first embodiment in FIG. 1. The configuration can cope with voltage output sensors that output 1 to 5 V.

According to this arrangement, thermocouple sensors can also be connected by using only the terminals (Vi) and (−).

Generally, a power source of at least 5 V is employed as a power supply unit 16 for sensors that output 1 to 5 V, or more appropriately, a power source of 9 V or higher may be employed.

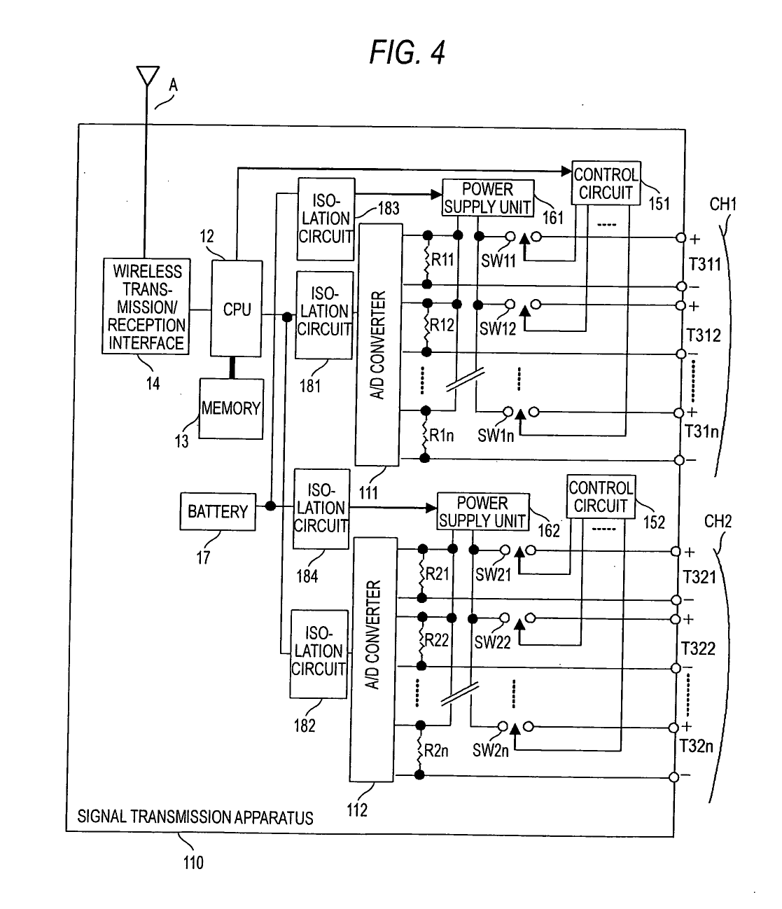

A third embodiment according to the present invention is shown in FIG. 4.

The basic configuration for this embodiment is the same as that for the first embodiment in FIG. 1, with the exception that a plurality of input channels, CH1 and CH2, are provided.

For channel CH1, signals are received from sensors by corresponding input terminals T311 to T31n, one of the signals is selected via one of multiple switches swll to swln, and analog/digital conversion is performed for the selected signal by an A/D converter 111. Resistors R11 to R1n are reception resistors.

Similarly, for channel CH2, signals are received from sensors by corresponding input terminals T321 to T32n, one of the signals is selected via one of multiple switches sw21 to sw2n, and analog/digital conversion is performed for the selected signal by an A/D converter 112. Resistors R21 to R2n are receiving resistors.

A CPU 12 performs various processes in accordance with a program stored in a memory 13, generates a communication frame in conformity with a wireless communication protocol, and transmits the communication frame to a wireless transmission/reception interface 14.

The wireless transmission/reception interface 14 transmits by radio, via an antenna A, a sensor signal, received from the CPU 12, to a host computer located in a remote area.

In accordance with an instruction received from the CPU 12, a control circuit 151 changes the ON/OFF states of the switches sw11 to sw1n to select a sensor signal to be accepted. Similarly, in accordance with an instruction received from the CPU 12, a control circuit 152 changes the ON/OFF states of the switches sw21 to sw2n to select a sensor signal that is to be accepted.

The signal transmission apparatus 110 further has power supply units 161 and 162. With these power supply units 161 and 162, the signal transmission apparatus 110 supplies power to the sensors connected to the terminals corresponding to the switches selected by the control circuits 151 and 152.

Isolation circuits 181 and 182 are located between the CPU 12, which is a signal processing circuit, and the A/D converters 111 and 112, and isolation circuits 183 and 184 are located between a battery 17 and the power supply units 161 and 162.

With this arrangement, the affect of a common mode voltage on the sensors can be reduced. The isolation circuits 181, 182, 183 and 184, for example, can be well known isolation transducers or photocouplers.

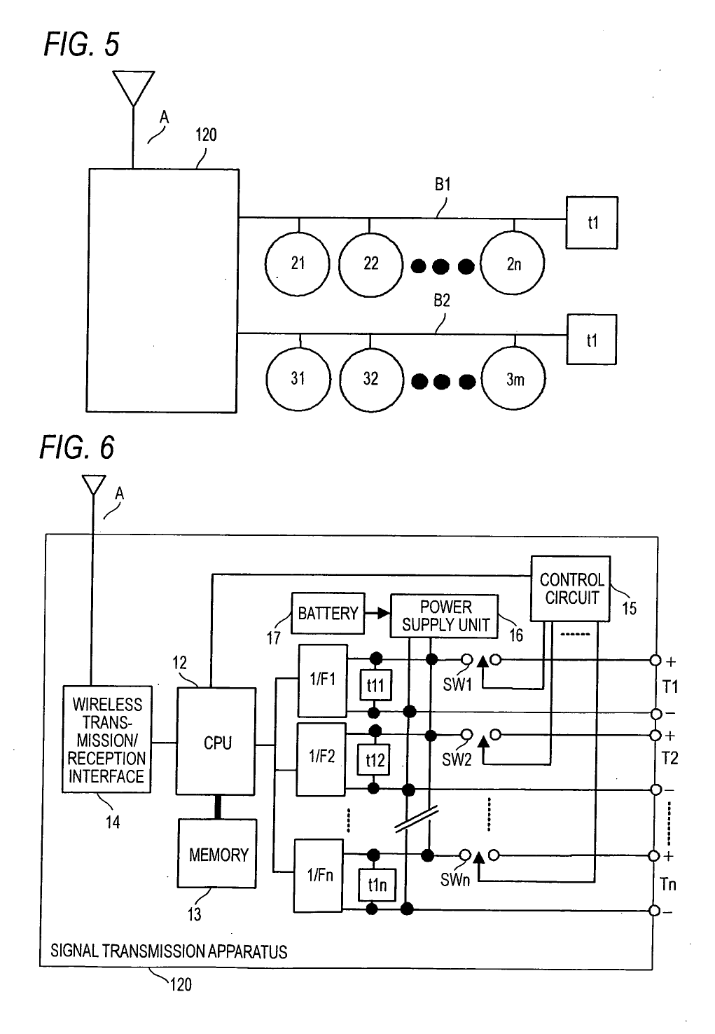

A fourth embodiment of the invention is shown in FIGS. 5 and 6.

In FIG. 5, sensors 21 to 2n and sensors 31 to 3m are respectively connected to buses B1 and B2, so that the sensor groups communicate with a signal transmission apparatus 120 via the buses. It should be noted that the buses B1 and B2 include terminators t1 and t2.

FIG. 6 is a diagram showing the detailed configuration of the signal transmission apparatus 120 according to this embodiment.

The basic configuration of the signal transmission apparatus 120 is the same as that of the signal transmission apparatus 10 in FIG. 1, with the exception that instead of the reception resistors R1 to Rn, terminators t11 to t1n are provided.

Since signals received from sensors by input terminals T1 to Tn are digital signals, an A/D converter is not required, and instead, bus interfaces I/F1 to I/Fn for digital communication are provided that correspond to the buses B1 and B2.

Since the only way in which the signal transmission apparatus 120 of this embodiment differs from the signal transmission apparatus 10 in FIG. 1 is that digital signals are handled instead of analog signals, and since otherwise the operation is the same as in the first embodiment in FIG. 1, no further explanation for this operation will be given.

A typical example digital communication bus for the processing industry is a Foundation Field Bus, a Profi Bus or a MOD Bus.

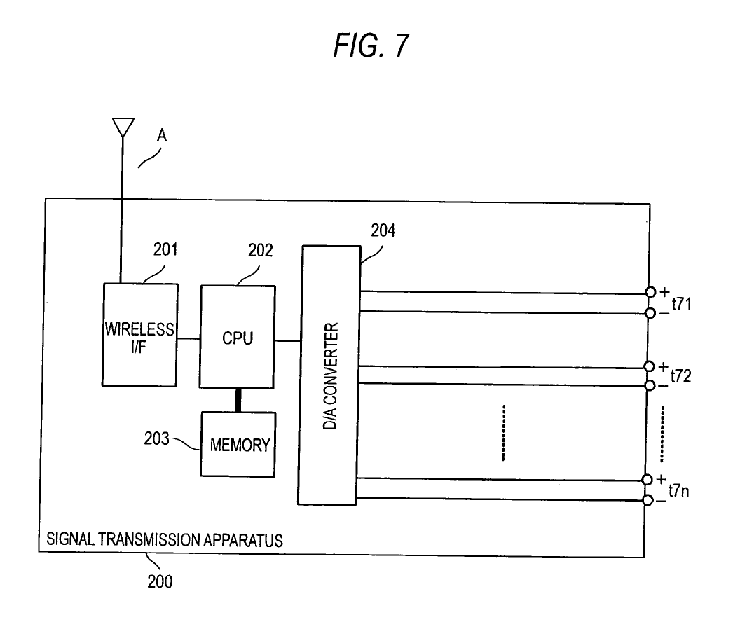

A signal transmission apparatus 200 according to a fifth embodiment of the invention is shown in FIG. 7.

In the first to the fourth embodiments, signals received from the sensors are processed; however, in this embodiment, the output of a signal to an actuator is handled.

Specifically, a wireless operation signal transmitted by a host computer (not shown) is received by a wireless I/F 201; a CPU 202, which is a signal processing circuit, processes the received signal in accordance with a program stored in a memory 203; and a D/A converter 204 outputs the obtained signal to one of the sensors via a corresponding terminal t1 to tn.

In this embodiment, after a signal is received from the host computer, the CPU 202 determines to which sensor the received signal should be output.

The signal transmission apparatus of the present invention has been employed for processing analog sensor signals that are input, for processing digital sensor signals that are input, and for outputting a signal to a sensor. However, the present invention is not limited to this, and a configuration wherein two or more channels, such as an analog signal input channel, a digital signal input channel and an output channel, are present in a single apparatus is also included within the scope of the invention.

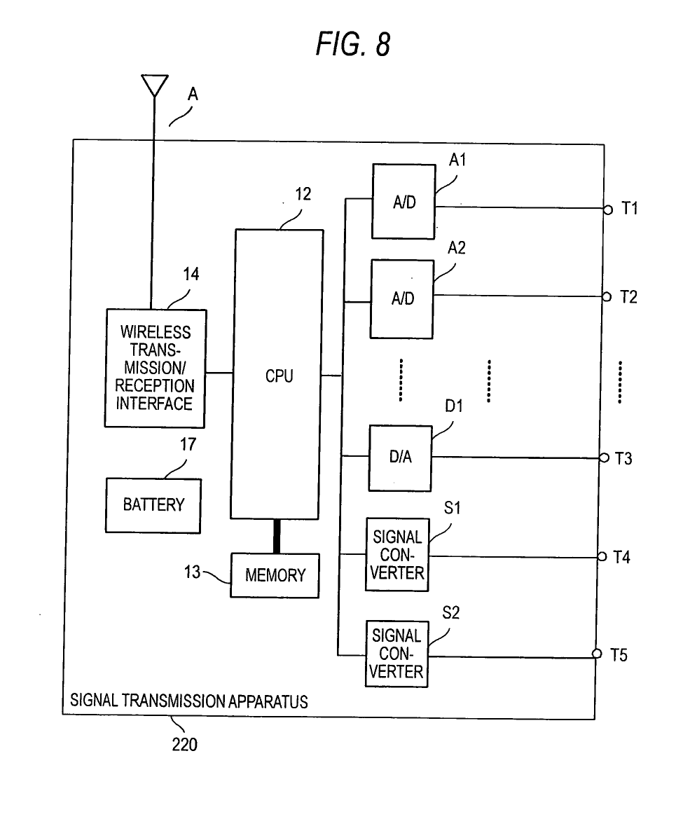

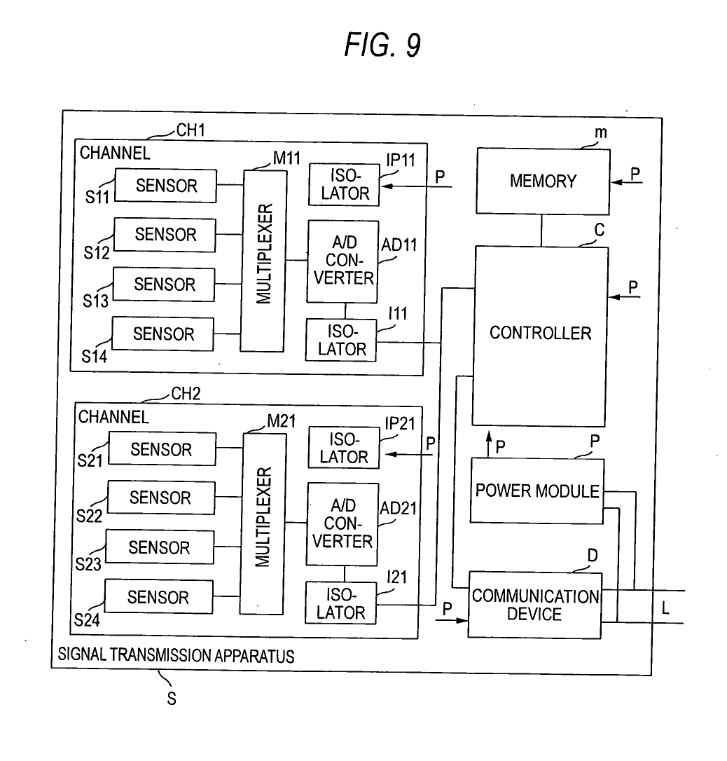

A sixth embodiment is shown in FIG. 8, wherein a plurality of channels, such as an analog signal input channel, an analog signal output channel, a digital signal input channel and a digital signal output channel, are present in a single apparatus.

In this embodiment, a signal transmission apparatus 220 includes analog input terminals T1 and T2, for receiving sensor signals; and an analog output terminal T3, a digital input terminal T4 and a digital output terminal T5 that are respectively connected to actuators.

Analog sensor signals are received at the analog input terminals T1 and T2 and are converted into digital signals by A/D converters A1 and A2. At this time, a CPU 12 performs a process for extracting a digital value obtained by the A/D converter A1 or A2. No switch selection means is required in this embodiment.

Thereafter, based on the extracted signal, the CPU 12 generates a communication frame in conformity with a wireless communication protocol, and changes this frame into a wireless transmission/reception communication frame that it transmits, via a wireless transmission/reception interface 14 and an antenna A, to a host computer located in a remote area.

When the host computer has transmitted a drive signal to drive the actuator connected to the analog output terminal T3, the drive signal is received as a communication frame, via the antenna A and the wireless transmission/reception interface 14, and the contents of the drive signal are translated by the CPU 12.

After the CPU 12 has completed this process, a D/A converter D1 converts the signal into an analog signal that is transmitted by the analog output terminal T3 to the corresponding actuator.

A digital signal is transmitted to the digital input terminal T4 by a device that outputs a digital signal, and a signal converter S1 changes the digital signal into a signal form to be processed by the CPU 12 and transmits the resultant signal to the CPU 12.

The CPU 12 transmits to the host computer located in a remote area, via the wireless transmission/reception interface 14 and the antenna A, as a communication frame, which is the digital signal that is obtained, at an appropriate timing, by the signal conversion.

When the host computer has issued a drive signal to drive the actuator connected to the digital output terminal T5, the drive signal is received as a communication frame, via the antenna A and the wireless transmission/reception interface 14, and is processed by the CPU 12.

After the CPU 12 has completed the processing, a signal converter S2 converts the signal into a digital signal for processing by a connected actuator, and the digital drive signal is transmitted by the digital output terminal T5 to the corresponding actuator.

A battery 17 may be a solar cell, and supplies power to the individual components in this embodiment.

As is described above, according to the sixth embodiment of the invention, signals can be received from various devices, such as sensors, and can be transmitted by radio to a host computer located in a remote area. Further, a wireless signal can be received from the host computer and a drive signal can be supplied to a connected device, such as an actuator.

According to the sixth embodiment, in accordance with the processing designated for the CPU 12 or a signal received from the host computer in a remote area, the terminals T1 to T5 can be arbitrarily set to receive signals from devices or to output signals to devices.

1. A signal transmission apparatus, to which at least one field device is connected and which transmits a signal obtained from the field device to a host computer, comprising:
at least one input terminal to which a signal transmitted from the field device is inputted;
a signal processing unit which generates a communication frame in conformity with a wireless communication protocol based on a signal inputted through the input terminal; and
a wireless transmission unit which transmits by wireless the communication frame to the host computer.

2. The signal transmission apparatus according to claim 1, further comprising:
a selection unit which selects a signal to be inputted to the signal processing unit among signals inputted through the input terminals.

3. The signal transmission apparatus according to claim 2, further comprising:
a power supply unit which supplies power to a field device transmitting a signal selected by the selection unit.

4. The signal transmission apparatus according to claim 3,
wherein a signal inputted to the signal processing unit is a signal transmitted from a field device to which the power supply unit supplies power.

5. The signal transmission apparatus according to claim 3,
wherein the power supply unit is backed up by a battery.

6. The signal transmission apparatus according to claim 5,
wherein the battery is a solar cell.

7. The signal transmission apparatus according to claim 1,
wherein the input terminal is a terminal which transmits and receives a signal having a current of 4 mA to 20 mA.

8. The signal transmission apparatus according to claim 1,
wherein the input terminals include a power supply terminal and a signal input terminal to which a signal transmitted from the field device is inputted.

9. The signal transmission apparatus according to claim 1,
wherein an isolation circuit which isolates signals is disposed between the input terminal and the signal processing unit.

10. The signal transmission apparatus according to claim 5,
wherein an isolation circuit which isolates signals is disposed between the power supply unit and the battery.

11. The signal transmission apparatus according to claim 1,
wherein the input terminal is connected to the signal processing unit through a bus interface for digital communication.

12. A signal transmission apparatus, to which at least one field device is connected and which transmits a signal obtained from the host computer to the field device, comprising:
a wireless receiving unit which receives a wireless signal transmitted from the host computer; and
a signal processing unit which performs a signal processing for the wireless signal and outputs an operation signal to a field device corresponding to the wireless signal.

13. A signal transmission apparatus, to which at least one field devices is connected and which is disposed between the field device and a host computer, comprising:
a signal processing unit which generates a communication frame in conformity with a wireless communication protocol based on a signal obtained from the field device, and generates a communication frame to be transmitted to the field device based on a signal in conformity with a communication protocol obtained from the host computer.
